(19) United States
(12) Patent Application Publication
(10) Pub. No.: US 2024/0415113 A1
(43) Pub. Date: Dec. 19, 2024

(54) COMPOSITION AND METHOD FOR ATTRACTING VESPID WASPS

(71) Applicant: BanfieldBio Inc., Woodinville, WA (US)

(72) Inventors: John Harvey Borden, Burnaby (CA); Alyssa Sue Branca, Woodinville, WA (US); Michael Gilbert Banfield, Woodinville, WA (US)

(73) Assignee: BanfieldBio Inc., Woodinville, WA (US)

(21) Appl. No.: 18/335,476

(22) Filed: Jun. 15, 2023

(51) Int. Cl. A01N 25/00; A01M 1/10; A01N 37/02

(52) U.S. Cl. CPC A01N 25/002; A01M 1/106; A01N 37/02; A01M 2200/012

(57) ABSTRACT

This invention demonstrates that enhanced captures of vespid wasps (Hymenoptera: Vespidae) can be achieved when the vespid receiving chamber of a trap is baited with lures in which an animal protein-based lure component like fish meal is combined with a plant-derived lure component that may include fruits, plant-based foodstuffs, one or more synthetic chemicals that are identical to compounds found naturally in plants, and inert ingredients.

### FIELD OF THE INVENTION

This invention pertains to improving catch of vespid wasps in traps baited with both plant-derived and animal-derived lure components.

### BACKGROUND OF THE INVENTION

Wasps in the family Vespidae (Hymenoptera) are worldwide pests (Akre et al. 1980, de Jong 1990, Beggs et al. 2011). They frequently sting humans, causing thousands of visits to hospitals every year (Langley et al. 2014), in part because their venom causes life-threatening anaphylactic shock in some people (Bonay et al. 1997, Faux et al. 1997, Vetter et al. 1999). They are also pests of the beekeeping industry, as they can attack honey bee hives to feed on honey and bee larvae (Clapperton et al. 1989, de Jong 1990).

Vespid wasps are generalist scavengers on both carbohydrate and protein resources. A common carbohydrate source is overripe fruit (Akre et al. 1980, Edwards 1980. Matsuura and Yamane 1990). Accordingly, one of the principal methods for managing vespid wasps is to capture them in traps baited with fruit, fruit-based substances, or synthetic volatile compounds identical to compounds found in fruits. Based on the finding that vespid wasps harbor yeasts in their guts and apparently inoculate fruit during feeding (Ibarra Jimenez et al. 2017), Babcock et al. (2017, 2018) found that adding yeast to fruit-based trap lures significantly increased captures in traps. Despite the attraction to fruit-based lures, much higher attraction can be achieved with synthetic fruit volatiles. Many such lures have been developed for trapping vespid wasps (Landolt 1998, Rust and Su 2012), including heptyl butyrate (MacDonald et al. 1973, El-Sayed et al. 2009), 2-methyl-1-butanol (Landolt et al. 2000, Day and Jeanne 2001), and blends of isobutanol, 2-methyl-2-propanol, 2-methyl-1-butanol or butyl butyrate and acetic acid (Landolt 1998, 2000; Landolt et al. 1999, 2000).

Additional plant-derived compounds that are attractive to vespid wasps include (but are not limited to) 2,4-hexadienyl butyrate (Davis et al. 1967, Eddy et al. 1969), 2-hexyl pentenoate, 2-ethyl heptynoate, hexyl tiglate, 2-hexyl hexenoate, 2-heptyl pentenoate, heptyl crotonate, heptyl tiglate (Davis et al. 1968), 2,4-hexadienyl isobutyrate, 2,4-hexadienyl propionate (Eddy et al. 1969), octyl butyrate (Davis et al. 1972), cis-3-hexenyl butyrate, 2-methylpentyl croatanate (Eddy et al. 1975), linalool, α-terpineol, (E)-2-hexenal (Aldrich et al. 1985, Aldrich 2004), and 2,4-ethyl decadienoate (Day and Jeanne 2001)

Heptyl butyrate was shown by Davis et al. (1969) to be highly attractive to vespid wasps. When deployed in an Oregon peach orchard for 10 days in 1969 traps baited with heptyl butyrate captured well over 800 western yellowjackets per trap (Davis et al. 1973). Heptyl butyrate is by far the most common synthetic chemical used in trap lures for vespid wasps, and having met stringent criteria for safety and efficacy, is the only synthetic vespid attractant approved for registration as a pesticide in the USA (EPA 2009).

In keeping with the role of vespid wasps as scavenger, an alternative type of trap lure has been sources of animal protein such as meat and fish. Fish and fish-based pet foods may be highly attractive (Wagner and Reierson 1969, Grothhaus et al. 1973, Ross et al. 1984, Spurr 1995, Wood et al. 2006). Other protein-based food lures include raw and cooked horsemeat (Grant et al. 1968, Ross et al. 1984), cooked hamburger (Grothaus et al. 1973), venison (Spurr 1995), canned and freeze-dried chicken (Wood et al. 2006, Reierson et al. 2008, Rust et al. 2017), freeze-dried kangaroo meat (Wood et al. 2006), and green-lipped mussels (Unelius et al. 2014). A major problem with fish and meat lures, either raw or processed, is that they spoil within 1-3 days (Wagner and Reierson 1969, Spurr 1995). Unlike fruit-based foods, few attractive compounds for vespid wasps have been identified from animal protein-based foods. However. Ross et al. (1984) demonstrated strong attraction to hexane extracts of horsemeat, and Unelius et al. (2014) identified several attractive compounds from green-lipped mussels.

Given the independently demonstrated attraction of fruit- and animal protein-based lures, one might hypothesize that attraction would be enhanced by combining them. However, when 50 μL of heptyl butyrate and 1 g of chicken meat extract were placed separately or together in the vespid wasp receiving chamber of a trap, traps baited with chicken extract caught far more vespid wasps than traps baited with heptyl butyrate or both lures together, leading to the conclusion that heptyl butyrate impeded entry into traps baited with the chicken extract (Liang and Petri 2017, Liang 2018). This finding teaches that placing a plant-based lure and an animal-based lure in the vespid receiving chamber of a trap will not enhance attraction of vespid wasps over that induced by either lure alone. Liang (2018) further teaches that enhanced attraction of vespid wasps to a trap achieved by combining a plant-based lure with an animal-based lure will occur only if the animal-based lure is placed in the vespid wasp receiving chamber of a trap, and the plant-based lure is placed near (but not in) the insect-receiving chamber.

### BRIEF SUMMARY

In a first aspect, commercial BioCare traps baited with an experimental lure comprised of the plant-derived components heptyl butyrate at 0.76 g/lure, red vinegar, dried apple, and dried tomato captured fewer vespid wasps than the commercial Rescue Disposable Bag Trap baited with the Rescue lure containing 2.4 g of heptyl butyrate.

In a second aspect, when said experimental lure and the Rescue heptyl butyrate lure were tested in identical bag traps, traps baited with the Rescue heptyl butyrate lure captured significantly more vespid wasps than traps baited with the experimental lure.

In a third aspect, adding fish meal at 0.23 g to the experimental lure improved catches of vespid wasps to a level 1.33× higher than in identical bag traps baited with the experimental lure alone. Conversely, adding chicken powder at 0.23 g to the experimental lure decreased catches of vespid wasps to a level 21.9% lower than in identical bag traps baited with the experimental lure alone.

In a fourth aspect, adding fish meal at 0.46 g or 0.69 g to the experimental lure improved catches of vespid wasps to respective levels 2.23× and 2.13× higher than in identical bag traps baited with the experimental lure alone.

In a fifth aspect, the first experiment was repeated in two widely separated locations, except that the BioCare traps were baited with the novel composition in which fish meal was added at 0.46 g to the experimental lure. In one experiment the traps baited with the novel composition caught 1.73× more vespid wasps than the commercial Rescue Disposable Bag Traps baited with the Rescue lure containing 2.4 g of heptyl butyrate. In the other experiment the superiority of traps baited with the novel composition rose to 2.00×.

Prior art teaches that combining plant-derived lure components with animal-derived lure components in the vespid wasp receiving chamber of a trap should decrease catches of vespid wasps to a level lower than that to the animal-derived lure alone and should not increase catches to a level higher than that achieved with the plant-derived lure component alone. The results of the above series of experiments refute this teaching and lead to the conclusion that combining fish-derived and plant-derived lure components can significantly and substantially improve the catch of vespid wasps in baited traps. Thus, the present invention comprises a novel method that involves combining such fish-derived and plant-derived lure components within traps in order to improve the catch-rate of vespid wasps.

### BRIEF DESCRIPTION OF THE DRAWINGS

Embodiments of the present invention are described in detail below with reference to the following drawings:

FIG. 1 is a graph demonstrating a comparison in Experiment 1 of mean catches of vespid wasps in the Rescue Trap with a Rescue Disposable Trap Lure (Table 1) and the BioCare trap with the experimental lure (Table 1);

FIG. 2 is a graph demonstrating a comparison in Experiment 2 of vespid wasp catches in Intko traps baited with the Rescue Disposable Trap Lure or the experimental lure (Table 1). Bars topped by different letters are significantly different (t-test, P<0.05);

FIG. 3 is a graph demonstrating the effect on vespid wasp trap catches in Experiment 3 of adding fish meal or chicken meal to the experimental lure (Table 1);

FIG. 4 is a graph demonstrating the effect on vespid wasp trap catches in Experiment 4 of increasing the dose of fish meal added to the experimental lure (Table 1). Bars topped by the same letter are not significantly different (Tukey's HSD test, P<0.05); and

FIG. 5 is a graph demonstrating the effect on vespid wasp trap catches in Experiments 5 and 6 of adding a double dose of fish meal to the experimental lure (Table 1) deployed in BioCare traps, relegating catches in the Rescue trap and lure treatment to a significantly inferior position. Bars topped by different letters are significantly different (t-test.P<0.05).

### DETAILED DESCRIPTION

Testing, innovative modification, and re-testing of experimental vespid wasp lures progressed through a series of incremental steps, as outlined seven Examples.

### EXAMPLE 1

### Experimental Lures

Table 1 lists all lures used in experiments conducted in Examples 2-7, with the exception of lures that included double and triple doses of fish meal.

The Rescue Disposable Trap and Lure, for use in western North America, is stated in the EPA-approved Master Label (25 Feb. 2014, EPA Registration No. 84565-6) as weighing 12.760 g (0.45 oz), with heptyl butyrate comprising 18.0% of the total weight. The lure is sold encased in a disposable plastic bag trap and when used separately was excised from the trap. The vendor for the trap and lure is Sterling International Ltd, Spokane, WA, USA.

While heptyl butyrate was utilized for this experiment, the invention could also be practiced with alternatively or additionally comprising compounds such as, but not limited to, 2-methyl-1-butanol, isobutanol, 2-methyl-2-propanol, butyl butyrate, acetic acid, 2,4-hexadienyl butyrate, 2-hexyl pentenoate, 2-ethyl heptynoate, hexyl tiglate, 2-hexyl hexenoate, 2-heptyl pentenoate, heptyl crotonate, heptyl tiglate, 2,4-hexadienyl isobutyrate, 2,4-hexadienyl propionate, octyl butyrate, cis-3-hexenyl butyrate, 2-methylpentyl croatanate, linalool, α-terpineol, (E)-2-hexenal, and 2,4-ethyl decadienoate.

The experimental lure contained components in identical amounts as in the commercial vespid wasp lure sold until 2020 under the BioCare trademark by Springstar Inc, Woodinville, WA, USA, and thereafter commercially available from Willert Home Products Inc., under the Eliminator and Enoz Trap-N-Kill brand names. When additional experimental components were added the weights and proportions of components were altered slightly, as shown in Table 1. The red vinegar, dried apple, and dry tomato represent plant-based foodstuffs and heptyl butyrate is a synthetic volatile identical to a compound found in various fruits, particularly apples and plums (EPA 2009). Other embodiments of the invention may use freeze-dried fruit and/or fruit powder as alternatives, or such other combinations of foodstuffs. The inert ingredients formulate the components into a dry powder, extend the longevity of the other components and regulate the release rate of attractive volatile compounds. Such inert ingredients, depending on the needs of a particular embodiment of the invention, can be include, but are not limited to, cellulosic substances such as wood pulp or powders that act as adsorbents and flowability agents; citric acid, butylated hydroxytoluene, sodium benzoate, sorbic acid, and similar compounds that function as preservatives; and polymeric sorbents such as polyacrylates and polyacrylamides that adsorb volatile compounds and release them into the air at controlled rates.

One of the test protein source additives was BioFlavor CP Chicken, a freeze-dried chicken powder produced by SPF North America, Greenwood, SC., as a “palatability enhancer for pet food products”. The other test protein source was Lighthouse Fish Meal 9-4-0, produced as a fertilizer from “fish of US origin” by Wilbur Ellis Company LLC, Yakima, WA, USA. Notwithstanding the foregoing, other embodiments may use alternative forms of the fish protein, such as cooked fish or dried fish. Various embodiments of the invention may utilize a variety of fish-derived proteins from species including, but not limited to those from phylum Chordata, superclass Agnatha (jawless fishes), class Chondrichthyes (cartilaginous fishes), or superclass Osteichthyes (bony fishes)

TABLE 1
Composition of the lures used in experiments conducted in Examples 2-7.

| | Rescue | | | | Experimental | | Experimental | |
|---|---|---|---|---|---|---|---|---|
| | Disposable | | Experimental | | lure with chicken | | lure with fish | |
| | Trap Lure | | lure | | powder added | | meal added | |
| COMPONENT | g/lure | % | g/lure | % | g/lure | % | g/lure | % |
| Heptyl butyrate | 2.412 | 18.9 | 0.759 | 30.4 | 0.694 | 27.6 | 0.694 | 27.6 |
| Red vinegar | — | — | 0.653 | 26.1 | 0.597 | 23.7 | 0.597 | 23.7 |
| Dried apple | — | — | 0.304 | 12.1 | 0.278 | 11.0 | 0.278 | 11.0 |
| Dry tomato | — | — | 0.287 | 11.5 | 0.262 | 10.4 | 0.262 | 10.4 |
| Chicken meal | — | — | — | — | 0.229 | 9.1 | — | — |
| Fish meal | — | — | — | — | — | — | 0.229 | 9.1 |
| Inert ingredients | 10.348 | 81.1 | 0.604 | 19.9 | 0.456 | 18.2 | 0.456 | 18.2 |
| TOTAL | 12.760 | 100 | 2.501 | 100 | 2.516 | 100 | 2.516 | 100 |

### EXAMPLE 2

### General Experimental Methodology

Experiments were set up in farms in the Langley area of the Lower Fraser Valley, BC, Canada, and in one instance in an apple orchard in Ellensburg, WA, USA. Traps were hung on wires supporting grape vines, on brushy vegetation bordering blueberry fields, or on the branches of apple trees.

Except as otherwise noted, all experiments had 12 replicates in randomized complete blocks with 10 m between traps. Lures were in 400 mL water with a small amount of non-scented detergent added, except for Rescue Disposable Trap Lures enclosed within a sealed bag trap. Experiments ran 2-9 days, just long enough for significant numbers of yellowjackets to be caught. Among those vespids targeted with the experiment, and for which the present invention is well suited, are those vespid wasps of the order Hymenoptera; family Vespidae; genera Vespa. Vespula, Dolichovespula, or Polistes, but the invention is not limited to such vespids.

At the field site, captured vespid wasps were separated from the catching solution by sieve, identified to species using abdominal markings (Akre et al. 1980) and counted. Western yellowjackets, Vespula pensylvanica, comprised over 90% of the vespid wasp species captured. Other species captured were Vespula alascensis, Vespula germanica and Vespula acadica. Mean catches were analyzed by ANOVA followed by Tukey's HSD test, except for pair-wise comparisons which were analyzed by t-tests. In all cases, the data were untransformed and α=0.05.

### EXAMPLE 3

### Comparison of Trap and Lure Compositions

Experiment 1 was conducted from 20-24 Jul. 2018 to compare the BioCare trap with the experimental lure (Table 1) against the western Rescue Disposable Trap and Lure, which is the predominant vespid wasp control device sold in retail outlets throughout western North America. The BioCare trap is a yellow cylindrical jar (20.3 cm high×7.6 cm diameter) with side entry holes. The experiment was set up in a vineyard in Langley, BC.

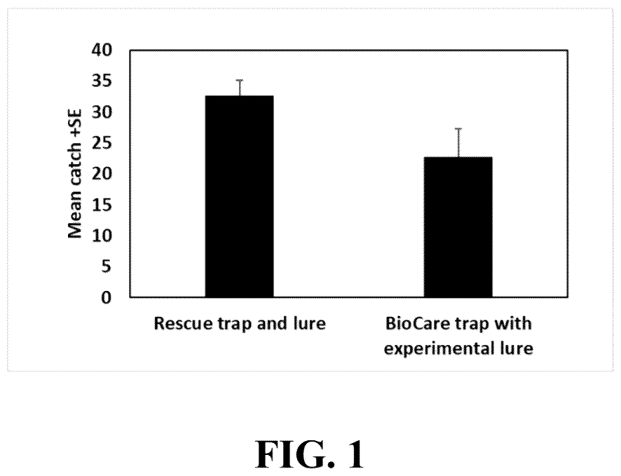

The Rescue Trap and Lure caught 32.67±2.54 (mean±SE) vespid wasps, 1.44× more than the 22.75±4.56 wasps caught in the BioCare trap baited with the experimental lure (FIG. 1). The difference between the catches approached significance (t=1.9018, df=22,P=0.0704). Because the two treatments comprised different traps and lures, it was impossible to discern whether the difference in trap captures was because of disparities in the performance of the traps or the lures.

### EXAMPLE 4

### Comparison of Different Lures in Identical Traps

To determine if the disparity in trap catches in Experiment 1 was caused by differences in the lures, Experiment 2 tested the two lures from Example 3 in identical disposable bag traps (Intko Supply Ltd, Chilliwack, BC, Canada). The experiment had 11 replicates and was run from 20-24 Jul. 2018 in the same vineyard as Experiment 1.

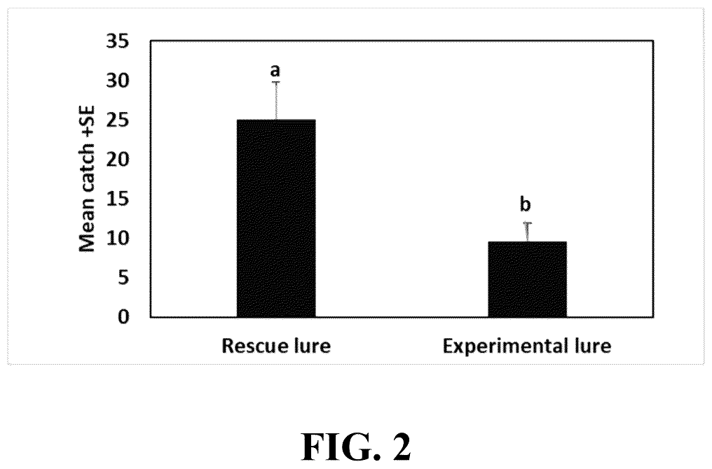

Traps baited with the Rescue Disposable Trap Lure caught 25.09±4.64 vespid wasps, 2.6× more than the 9.64±2.34 wasps caught in traps baited with the experimental lure (FIG. 2). The difference in mean trap catch was highly significant (t=2.9715, df=20, P=0.0075). The results strongly indicate that the difference between the complete trap and lure compositions in Experiment 1 was caused mainly by a difference in performance of the lures.

### EXAMPLE 5

### Effect of Adding Animal Protein-Based Foods to the Experimental Lure

To determine if adding an animal protein-based lure component to the experimental lure would improve trap catches, fish meal, or chicken powder was added to the experimental lure in Experiment 3 and the performance of the modified lures was compared to that of the experimental lure alone. The experiment employed Intko bag traps, was set up on the margins of a commercial blueberry farm in Langley, BC, and ran from 27-31 Jul. 2018.

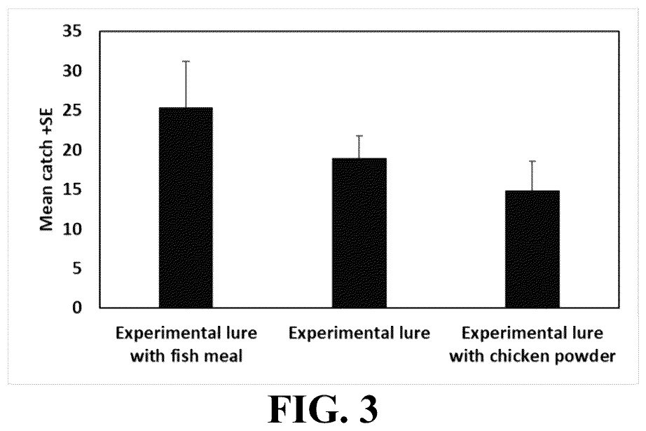

Although the differences among trap catches were not significant (F=1.4926, df=2.33, P=0.2396), traps baited with lures to which fish meal was added caught 25.33±5.89 vespid wasps, 1.33× more than the 19.00±2.78 vespid wasps caught in traps baited with the experimental lure (FIG. 3). Conversely, the 14.83±3.70 catch of vespid wasps in traps baited with lures to which chicken powder was added declined to a level 21.9% lower than the catch in traps baited with the experimental lure (FIG. 3). The positive result with the novel composition comprising fish meal added to the experimental lure (FIG. 3) would not have been predicted by the results of the experiment conducted by Liang and Petri (2017), in which placing chicken extract and heptyl butyrate in the same trap greatly reduced trap catches compared to that with chicken extract alone.

### EXAMPLE 6

### Effect of Increasing the Dose of Fish Meal on Vespid Wasp Trap Catches

To determine if the positive effect of adding fish meal to the experimental lure in Experiment 3 was real, Experiment 4 tested the effect of doubling or tripling the fish meal dose. It employed Intko traps and was run from 14-17 Aug. 2018 in the same vineyard as Experiments 1 and 2. It tested the effect of adding fish meal to the experimental lure at the same dose as in Experiment 3 (Table 1), and at double and triple that dose.

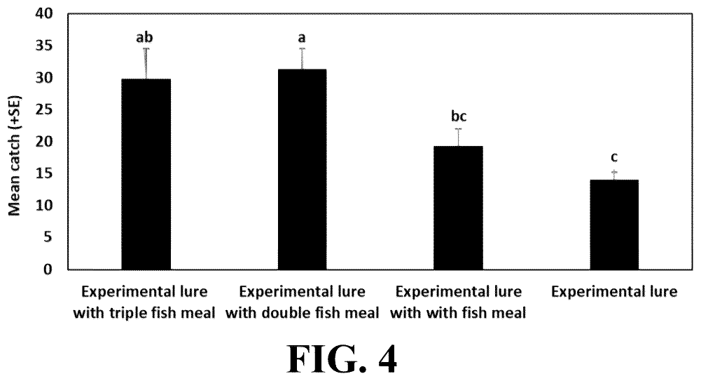

As in Experiment 3, adding fish meal to the experimental lure improved vespid wasp catches by a non-significant 1.38× (19.25±2.71 vespid wasps in traps baited with the experimental lure plus a single fish meal dose compared to 14.00±1.18 wasps in traps baited with the experimental lure). Doubling or tripling the fish meal dose improved the trap catches significantly by 2.23× (31.25±4.81 vespid wasps) and 2.13× (29.75±3.11 vespid wasps), respectively (FIG. 4). This result is in complete contrast to that of Liang and Petri (2017), wherein the presence of heptyl butyrate appeared to inhibit the catch of vespid wasps in traps that were also baited with an animal protein source. It strongly indicates that if the lure components and their dose are appropriately chosen and adjusted, it is possible to more than double catches of vespid wasps in traps that are baited with both plant-derived stimuli and a source of animal-derived protein.

### EXAMPLE 7

### Comparative Performance of the Rescue Trap and Lure Composition and the Composition Comprising the BioCare Trap with a Double Fish Meal Modified Lure

Experiments 5 and 6 duplicated the treatments in Experiment 1, except that the experimental lure in the BioCare trap was replaced by a composition comprising the experimental lure combined with a double dose (0.458 g) of fish meal. Experiment 5 had six replicates and was run from 31 August to 4 Sep. 2018 in the same vineyard as Experiments 1, 2 and 4. Experiment 6 was run from 4-13 Sep. 2018 in an apple orchard in Ellensburg, WA, USA.

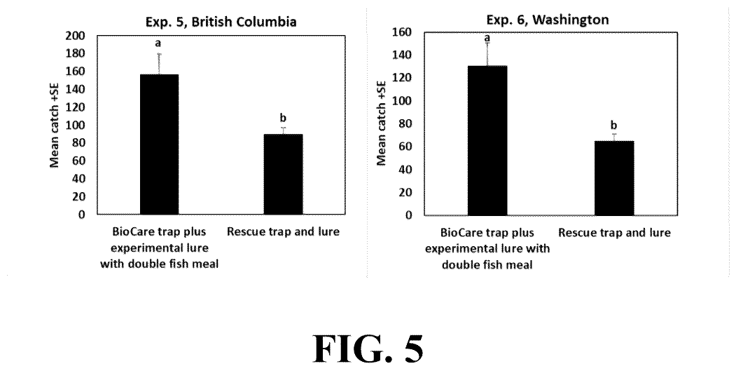

Employing the modified experimental lure composition with a double dose of fish meal in Experiments 5 and 6 reversed the performance of traps found in Experiment 1, and significantly relegated the Rescue trap and lure to an inferior position (t=2.7658, df=10, P=0.0199 for Experiment 5 and t=3.0690, df=22, P=0.0056 for Experiment 6) (FIG. 5). In Experiment 5 the mean catch of 156.67±23.02 vespid wasps in BioCare traps with the modified experimental lure with a double fish meal dose was 1.73× the 90.33±6.50 wasps caught in the Rescue trap and lure treatment, and in Experiment 6 the superiority of the mean catch of 130.50±20.49 vespid wasps in traps baited with the modified experimental lure with a double fish meal dose improved to 2.00× the 65.17±5.79 catch in the Rescue trap and lure treatment.

The results of Experiments 5 and 6 confirm the conclusion that combining a fish-derived lure component with a plant-derived lure component in the vespid wasp receiving chamber of a trap can significantly and substantially improve the catch of vespid wasps in baited traps. As demonstrated from the variety of trap types utilized in the experiments, the present invention could function with a variety of trap configurations and should not be read as limited to any specific variant. Similarly, it should be understood based on the foregoing that the exact mixture of the proteins utilized can vary based on the embodiment, and that exact amounts used should not be read as limiting.

Depending on the needs of the embodiment, the percentage composition per lure of plant-derived foodstuffs ranges from 1% to 90%, the percentage composition per lure of one or more synthetic chemicals substantially identical to compounds occurring naturally in plants ranges from 1% to 90%, the percentage composition per lure of an animal-derived lure component ranges from 1% to 90%, and the percentage composition per lure of inert ingredients ranges from 1% to 90%.

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

The foregoing examples should be viewed as demonstrations of potential embodiments and are not exhaustive or necessarily conclusive as to the effectiveness of the present invention. In many situations, it may be preferable to utilize mixtures and conditions different from the above or use an embodiment of the invention which an example may have indicated was less effective but may be more optimal in such situation.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application. Many changes, modifications, variations and other uses and applications of the present construction will, however, become apparent to those skilled in the art after considering the specification and the accompanying figures. All such changes, modifications, variations and other uses and applications which do not depart from the spirit and scope of the invention are deemed to be covered by the invention which is limited only by the claims which follow.

It should be understood that while certain preferred forms, embodiments, and examples of this invention have been illustrated and described, the present invention is not to be limited to the specific forms or arrangement of parts described and shown, and that the various features described may be combined in other ways than those specifically described without departing from the scope of the present invention.

### REFERENCES CITED

### U.S. Patent Documents

Aldrich, J. R. 2004. Chemical attractants for yellowjacket wasps. U.S. Pat. No. 6,740,319.
Eddy, G. W., H. G. Davis, M. Beroza, and T. P. McGovern. 1969. Attractants for yellow jackets (Vespula spp.; Vespidae). U.S. Pat. No. 3,485,868.
Eddy, G. W., H. G. Davis, M. Beroza, and T. P. McGovern. 1975. Attractants for yellow jackets (Vespula spp.; Vespidae). U.S. Pat. No. 3,912,810.
Landolt, P. J. 2000. Chemical attractants for yellowjackets and paper wasps. U.S. Pat. No. 6,083,498.
Liang, D. 2018. Insect attraction through spatial partitioning of attractants. US Patent Application Publication US 2018/0213765.

### OTHER PUBLICATIONS

Akre, R. D., A. Greene, J. F. MacDonald, P. J. Landolt, and H. G. Davis. 1980. The yellowjackets of America north of Mexico. Agricultural Handbook No. 552. United States Department of Agriculture, Washington, DC.
Aldrich, J. R., J. P. Kochansky, and J. D. Sexton. 1985. Chemical attraction of the eastern yellowjacket, Vespula maculifrons (Hymenoptera: Vespidae). Experientia 41: 420-422.
Babcock, T., R. Gries, J. Borden, L. Palmero, A. Mattiacci, M. Masciocchi, J. Corley, and G. Gries. 2017.
Brewer's yeast, Saccharomyces cerevisiae, enhances attraction of two invasive yellowjackets (Hymenoptera: Vespidae) to dried fruit and fruit powder. J. Insect Sci. 17(5): 91.
Babcock, T., J. Borden, R. Gries, C. Carroll. M. Moore, and G. Gries. 2018. Lachancea thermotolerans, a yeast symbiont of yellowjackets, enhances attraction of three yellowjacket species (Hymenoptera: Vespidae) to fruit powder. Environ. Entomol. 47: 1553-1559.
Beggs, J. R., E. G. Brockerhoff, J. C. Corley, M. Kenis, M. Masciocchi, F. Muller, Q. Rome, and C. Villemant. 2011. Ecological effects and management of invasive alien Vespidae. BioControl. 56: 505-526.
Bonay. M., H. Echchakir, D. Lecossier, P. Laine, D. Herman, A. J. Hance, P. Soler, and A. Tazi. 1997. Characterization of proliferative responses and cytokine mRNA profiles induced by Vespula venom in patients with severe reactions to wasp stings. Clin. Exp. Immunol. 109: 342-350.
Clapperton, B. K., P. A. Alspach, H. Moller, and A. G. Matheson. 1989. The impact of common and German wasps (Hymenoptera: Vespidae) on the New Zealand beekeeping industry. New Zeal. J. Zool. 16: 325-332.
Davis, H. G., G. W. Eddy, T. P. McGovern, and M. Beroza. 1967. 2,4-hexadienyl butyrate and related compounds highly attractive to yellow jackets (Vespula spp.). J. Med. Entomol. 4: 275-280.
Davis, H. G., T. P. McGovern, G. W. Eddy, T. E. Nelson, K. M. R. Bertun, M. Beroza, and J. C. Ingangi. 1968. New chemical attractants for yellow jackets (Vespula spp.). J. Econ. Entomol. 61: 459-462.
Davis, H. G., G. W. Eddy, T. P. McGovern, and M. Beroza. 1969. Heptyl butyrate, a new synthetic attractant for yellow jackets. J. Econ. Entomol. 62: 1245.
Davis, H. G., R. J. Peterson, W. M. Rogoff. T. P. McGovern, and M. Beroza. 1972. Octyl butyrate, an effective attractant for the yellowjacket. Environ. Entomol. 1: 673-674.
Davis, H. G., R. W. Zwick, W. M. Rogoff, T. P. McGovern, and M. Beroza. 1973. Perimeter traps baited with synthetic lures for suppression of yellowjackets in fruit orchards. Environ. Entomol. 2: 569-571.
Day, S. E., and R. L. Jeanne. 2001. Food volatiles as attractants for yellowjackets (Hymenoptera: Vespidae). Environ. Entomol. 30: 157-165.
de Jong, D. 1990. Insects: Hymenoptera (ants, wasps, and bees), pp. 135-155. In R. A. Morse, and R. Nowogrodzki (eds.), Honey bee pests, predators. Cornell University Press, Ithaca, NY.
Edwards, R. 1980. Social wasps: their biology and control. Rentokil Ltd., East Grinstead, West Sussex, England.
El-Sayed, A. M., L. A. Manning, C. R. Unelius, K. C. Park, L. D. Stringer, N. White, B. Bunn, A. Twidle, and D. M. Suckling. 2009. Attraction and antennal response of the common wasp, Vespula vulgaris (L.), to selected synthetic chemicals in New Zealand beech forests. Pest Manag. Sci. 65: 975-981.
EPA. 2009. Biopesticides registration action document. Heptyl butyrate. PC Code 100247. US Environmental Protection Agency, Office of Pesticide Programs, Biopesticides and Pollution Prevention Division, Washington, DC, USA
Faux, J. A., M. F. Moffatt, A. Lalvani, J. Dekker, D. A. Warrell, and W. O. C. Cookson. 1997. Sensitivity to bee and wasp venoms: association with specific IgE responses to the bee and wasp venom and HLA DRB1 and DPB1. Clin. Exp. Allergy. 27: 578-583.
Grant, C. D., C. J. Rogers, and T. H. Lauret. 1968. Control of ground-nesting yellow jackets with toxic baits—a five-year testing program. J. Econ. Entomol. 61: 1653-1656.
Grothaus, R. H., H. G. Davis, W. M. Rogoff, J. A. Fluno, and J. M. Hirst. 1973. Baits and attractants for East Coast yellowjackets, Vespula spp. Environ. Entomol. 2: 717-718.
Ibarra Jimenez, S., C. Carroll, T. Babcock, N. Derstine, A. Hadwin, M. Moore, and G. Gries. 2017. Yeasts harboured by vespine wasps in the Pacific Northwest. Environ. Entomol. 46: 217-225.
Landolt, P. J. 1998. Chemical attractants for trapping yellowjackets Vespula germanica and Vespula pensylvanica (Hymenoptera: Vespidae). Environ. Entomol. 27: 1229-1234.
Landolt, P. J., H. C. Reed, J. R. Aldrich, A. L. Antonelli, and C. Dickey. 1999. Social wasps (Hymenoptera: Vespidae) trapped with acetic acid and isobutanol. Fla. Entomol. 82: 609-614.
Landolt, P. J., C. S. Smithhisler, H. C. Reed, and L. M. McDonough. 2000. Trapping social wasps (Hymenoptera: Vespidae) with acetic acid and saturated short chain alcohols. J. Econ. Entomol. 93: 1613-1618.
Langley, R., K. Mack, T. Haileyesus, S. Proescholdbell, and J. L. Annest. 2014. National estimates of noncanine bite and sting injuries treated in US hospital emergency departments, 2001-2010. Wilderness Environ. Med. 25: 14-23.
Liang, D., and J. E. Petri. 2017. Enhanced trapping of yellowjacket wasps (Hymenoptera: Vespidae) via spatial partitioning of attractants. Insects 8: 17.
MacDonald, J. F., R. D. Akre, and W. B. Hill. 1973. Attraction of yellowjackets (Vespula spp.) to heptyl butyrate in Washington State (Hymenoptera: Vespidae). Environ. Entomol. 2: 375-380.
Matsuura, M., and S. Yamane. 1990. Biology of the vespine wasps. Springer Verlag. Berlin, Germany.
Reierson, D. A., M. K. Rust, and R. S. Vetter. 2008. Traps and protein bait to suppress populations of yellowjackets (Hymenoptera: Vespidae). Pp. 267-274. In Proc. Sixth Internat. Conf. Urban Pests. W. H. Robinson and D. Bajomi (eds). OOK-Press Kft., H-8200 Veszprém, Pápai út 37/a, Hungary.
Ross, D. R., R. H. Shukle, and J. F. MacDonald. 1984. Meat extracts attractive to scavenger Vespula in Eastern North America (Hymenoptera: Vespidae). J. Econ. Entomol. 77: 637-642.
Rust, M. K., and N. Y. Su. 2012. Managing social insects of urban importance. Annu. Rev. Entomol. 57: 355-375.
Rust, M. K., D.-H. Choe, E. Wilson-Rankin, K. Campbell, J. Kabashima, and M. Dimson. 2017. Controlling yellow jackets with fipronil-based protein baits in urban recreational areas. Internat. J. Pest Manage. 63: 234-241.
Spurr, E. B. 1995. Protein bait preferences of wasps (Vespula vulgaris and V. germanica) at Mt Thomas, Canterbury. New Zealand. New Zealand J. Zool. 22: 281-289.
Unelius, C. R., A. M. El-Sayed, A. M. Twidle, L. D. Stringer, L. M. Manning, T. E. S. Sullivan, R. L. Brown, and A. D. L. Noble. 2014. Volatiles from green-lipped mussel as a lead to vespid wasp attractants. J. Appl. Entomol. 138: 87-95.
Vetter, R. S., P. K. Visscher, and S. Camazine. 1999. Mass envenomations by honey bees and wasps. West. J. Med. 170: 223-227.
Wagner, R. E. and D. A. Reierson. 1969. Yellow jacket control by baiting. 1. Influence of toxicants and attractants on bait acceptance. J. Econ. Entomol. 62: 1192-1197.
Wood, G. M., D. C. Hopkins, and N. A. Schellhorn. 2006. Preference by Vespula germanica (Hymenoptera: Vespidae) for processed meats: implications for toxic baiting. J. Econ. Entomol. 99: 263-267.

What is claimed is:

1. A vespid wasp-attractive and trapping composition comprising a trap comprising at least a vespid wasp receiving chamber in which one or more plant-based foodstuff lure components, one or more synthetic chemicals substantially identical to one or more chemicals found occurring naturally in plants, and one or more animal-based lure components are placed together with inert ingredients in the vespid wasp receiving chamber of the trap.

2. The composition of claim 1, wherein the plant-derived foodstuff lure component is at least one of: red vinegar, dried apple, dry tomato, freeze-dried fruit, and fruit powder.

3. The composition of claim 1, wherein one or more synthetic chemicals identical to one or more chemicals found occurring naturally in plants are selected from the group including heptyl butyrate, 2-methyl-1-butanol, isobutanol, 2-methyl-2-propanol, butyl butyrate, acetic acid, 2,4-hexadienyl butyrate, 2-hexyl pentenoate, 2-ethyl heptynoate, hexyl tiglate, 2-hexyl hexenoate, 2-heptyl pentenoate, heptyl crotonate, heptyl tiglate, 2,4-hexadienyl isobutyrate, 2,4-hexadienyl propionate, octyl butyrate, cis-3-hexenyl butyrate, 2-methylpentyl croatanate, linalool, α-terpineol, (E)-2-hexenal, and 2,4-ethyl decadienoate.

4. The composition of claim 3, wherein the synthetic chemical that is substantially identical to a chemical occurring naturally in plants is heptyl butyrate.

5. The composition of claim 1, wherein the animal-derived lure component is chosen from at least one of: cooked fish, dried fish, or fish meal.

6. The composition of claim 5, wherein the animal-derived lure component comprising the cooked fish, dried fish or fish meal is chosen from at least one of: phylum Chordata, superclass Agnatha (jawless fishes), class Chondrichthyes (cartilaginous fishes), or superclass Osteichthyes (bony fishes).

7. The composition of claim 5, wherein the fish meal is deployed as one of a dry powder or combined with water.

8. The composition of claim 1, wherein the inert ingredients are configured to perform at least one of: stabilizing the formulation, extending the longevity of other components, or regulating the release rate of attractive volatile compounds.

9. The compositions of claim 1, wherein the inert ingredients are selected from the group including cellulosic substances that act as adsorbents and flowability agents; citric acid, butylated hydroxytoluene, sodium benzoate and sorbic acid that act as preservatives; and polymeric sorbents that adsorb volatile compounds and release them into the air at controlled rates.

10. The composition of claim 1, wherein the total weight of all lure components ranges from 0.5 g to 50 g.

11. The composition of claim 1, wherein the percentage composition per lure of plant-derived foodstuffs ranges from 1% to 90%, the percentage composition per lure of one or more synthetic chemicals substantially identical to compounds occurring naturally in plants ranges from 1% to 90%, the percentage composition per lure of an animal-derived lure component ranges from 1% to 90%, and the percentage composition per lure of inert ingredients ranges from 1% to 90%.

12. The composition of claim 1, wherein the attracted vespid wasps are in the order Hymenoptera, family Vespidae.

13. The composition of claim 11, wherein the vespid wasps are in the genera Vespa, Vespula, Dolichovespula, or Polistes.

14. A method of attracting and trapping vespid wasps, the method comprising: employing a trap in which one or more plant-based foodstuff lure components, one or more synthetic chemicals substantially identical to one or more chemicals found occurring naturally in plants, and one or more animal-based lure components are placed together with inert ingredients in the vespid wasp receiving chamber of the trap.

15. The method of claim 14, wherein the vespid wasp-attractive composition lure is used to attract vespid wasps to a station where they are exposed to and acquire a lethal insecticide.

16. The method of claim 15, wherein the lethal insecticide can be at least one of a toxicant, a pathogen, or a growth regulator.
